(19) United States
(12) Patent Application Publication
(10) Pub. No.: US 2026/0241852 A1
(43) Pub. Date: Aug. 20, 2026

(54) VEHICLE HEADLAMP DEVICE AIMING SYSTEM AND VEHICLE HEADLAMP DEVICE AIMING METHOD

(71) Applicant: SUBARU CORPORATION, Tokyo (JP)

(72) Inventors: Kentaro YAMASAKI, Tokyo (JP); Makoto KINOSHITA, Tokyo (JP); Noriaki ASANO, Tokyo (JP); Shunichi NAKAMURA, Tokyo (JP)

(21) Appl. No.: 18/849,693

(22) PCT Filed: May 31, 2023
(86) PCT No.: PCT/JP2023/020325

§ 371 Date: Sep. 23, 2024

(51) Int. Cl. B60Q 1/14; F21S 41/663

(52) U.S. Cl. CPC B60Q 1/143; F21S 41/663

(57) ABSTRACT

A vehicle headlamp device aiming system includes: an in-vehicle camera that captures a front image of a vehicle; a headlamp device that sets a light illumination range in front of the vehicle; and a controller that performs variable light distribution control of identifying a light-reduction or light-blocking region in the light illumination range, based on a captured image by the in-vehicle camera. The controller: sets, in the headlamp device, a specific illumination unit whose illumination position is a specific position in a captured image of a calibration illumination target surface captured by the in-vehicle camera, at a time of initial setting; and detects a deviation between the specific position and the illumination position of the specific illumination unit, in the captured image of the calibration illumination target surface captured by the in-vehicle camera, and corrects an output of the variable light distribution control in accordance with the deviation.

### TECHNICAL FIELD

The invention relates to a vehicle headlamp device aiming system and a vehicle headlamp device aiming method.

### BACKGROUND ART

When a vehicle headlamp device is assembled to a vehicle body, aiming is performed to adjust a direction of an optical axis. A system that performs aiming automatically has been proposed in order to eliminate variation of the aiming due to human work. In a fixed attitude of a vehicle, the system illuminates a screen installed in front of the vehicle with a predetermined light distribution pattern by a lamp unit of a headlamp device. The system acquires a deviation between a target position of the light distribution pattern and a reference position in front of the vehicle corresponding to the target position, based on image information of an imaging device. The system drives an optical axis displacement unit in a such a manner that the target position of the light distribution pattern and the reference position in front of the vehicle match each other by using the acquired information on the deviation (see Patent Document 1 below).

In addition, recent vehicles are equipped with a variable light distribution system for a vehicle headlight, called ADB (Adaptive Driving Beam). The variable light distribution system detects the presence or absence of a front vehicle, an oncoming vehicle, or a pedestrian, based on a captured image by an in-vehicle camera to be used for an ADAS (Advanced Driving Assistant System) or the like, and identifies the position thereof by image processing. The variable light distribution system partially reduces or blocks light of an illumination region of the headlamp corresponding to the identified position, for example, to reduce glare given to a driver of the front vehicle or the oncoming vehicle or the pedestrian (see Patent Document 2 below).

### Citation List

### Patent Literature

Patent Literature 1: Japanese Patent No. 5331803
Patent Literature 2: Japanese Unexamined Patent Application Publication No. 2014-216087

### SUMMARY OF INVENTION

### Problem to Be Solved by the Invention

Also in a headlamp device that performs the variable light distribution control of ADB (hereinafter, ADB control) described above, when replacing the headlamp device, for example, a direction of an optical axis of the headlamp can deviate with respect to a vehicle body axis or an optical axis of an in-vehicle camera, and aiming has to be performed accordingly. However, when replacing the headlamp device, it can be difficult to adjust the direction of the optical axis as described above due to regulatory limitations or facility limitations. In such a case, the ADB control is performed in a state where the optical axis of the headlamp device is deviated with respect to the optical axis of the in-vehicle camera, causing a deviation between a specific position detected based on a captured image by the in-vehicle camera and a light-reduction or light-blocking region set in accordance with the position. This causes an issue that glare suppression by the ADB control is disabled.

The invention aims to address such an issue. In other words, an object of the invention is to, in a headlamp device equipped with a variable light distribution system that performs ADB control, enable a glare suppression function by the ADB control without adjusting an optical axis of the headlamp device, at the time of replacement of the headlamp device, for example.

### Means for Solving the Problem

To solve the above-described problem, an aspect of the invention provides a vehicle headlamp device aiming system including an in-vehicle camera, a headlamp device, and a controller. The in-vehicle camera is configured to capture a front image of an own vehicle. The headlamp device is configured to set a light illumination range in front of the own vehicle. The controller is configured to perform variable light distribution control of identifying a light-reduction or light-blocking region in the light illumination range, based on a captured image by the in-vehicle camera. The controller is configured to: set, in the headlamp device, a specific illumination unit whose illumination position is a specific position in a captured image of a calibration illumination target surface captured by the in-vehicle camera, at a time of initial setting; and detect a deviation between the specific position and the illumination position of the specific illumination unit, in the captured image of the calibration illumination target surface captured by the in-vehicle camera, and corrects an output of the variable light distribution control in accordance with the deviation.

### Effects of the Invention

According to the invention having such characteristics, even if a deviation occurs between the optical axis of the headlamp device and the vehicle body axis or the optical axis of the in-vehicle camera at the time of replacement of the headlamp device, for example, it is possible to ensure the effectiveness of the ADB control without adjusting the optical axis of the headlamp device.

### BRIEF DESCRIPTION OF DRAWINGS

FIG. 1 is an explanatory diagram illustrating a vehicle headlamp device aiming system according to an embodiment of the invention.

FIG. 2 is an explanatory diagram illustrating a hardware configuration of an ECU.

FIG. 3 is an explanatory diagram illustrating an operation flow of an initial setting operation mode.

FIG. 4 is an explanatory diagram of the initial setting operation mode.

FIG. 5 is an explanatory diagram illustrating an operation flow of an operation mode at the time of replacement.

FIG. 6 is an explanatory diagram of the operation mode at the time of replacement.

FIG. 7 is an explanatory diagram illustrating an operation flow of an ADB control operation mode.

FIG. 8 is an explanatory diagram of the ADB control operation mode.

### MODES FOR CARRYING OUT THE INVENTION

Some embodiments of the invention are described below with reference to the drawings. In the following description, the same reference numerals in different drawings indicate parts with the same functions, and redundant description in each drawing is omitted as appropriate.

A vehicle headlamp device aiming system (hereinafter, system) 1 according to an embodiment of the invention is mounted on a vehicle body B, and includes an in-vehicle camera 2, a headlamp device 3, and a controller 10. A screen S with a calibration illumination target surface Sa to be opposed to the in-vehicle camera 2 is also provided as a facility for operation of the system 1.

The in-vehicle camera 2 is configured to capture at least a front image of the vehicle B serving as an own vehicle, and is, for example, a camera that acquires a detected image to be used for an ADAS (Advanced Driving Assistant System). When ADB control is performed, the in-vehicle camera 2 acquires the front image of the vehicle B in order to identify a target of glare suppression. In addition, the in-vehicle camera 2 captures an image of the calibration illumination target surface Sa of the screen S at the time of initial setting or calibration.

The headlamp device 3 includes at least a light source unit 3A configured to perform the ADB control. The light source unit 3A is configured to individually turn on and off segmented multiple illumination units (lighting segments), and may include, for example, an LED (Light Emitting Diode) array or MEMS (Micro Electro Mechanical Systems) devices such as DMDs (Digital Micromirror Devices).

The control unit 10 includes multiple in-vehicle ECUs (Electronic Control Units). One of the in-vehicle ECUs included in the control unit 10 is an ECU 11 for in-vehicle camera control. Image data captured by the in-vehicle camera 2 is transmitted to the ECU 11, and the in-vehicle camera 2 is controlled by an output from the ECU 11. Another one of the ECUs included in the control unit 10 is an ECU 12 for headlamp device control. The ECU 12 controls lighting of the light source unit 3A of the headlamp device 3 in the illumination units, and controls an actuator or the like of the headlamp device 3.

The ECUs 11 and 12 in the controller 10 are communicably coupled to each other by an in-vehicle network 13 such as a CAN (Controller Area Network) or a LIN (Local Interconnect Network). In addition, the ECUs 11 and 12 are coupled to a central gateway (CGW ECU) 14 as a relay device, and communicably coupled to another in-vehicle ECU, which is not illustrated.

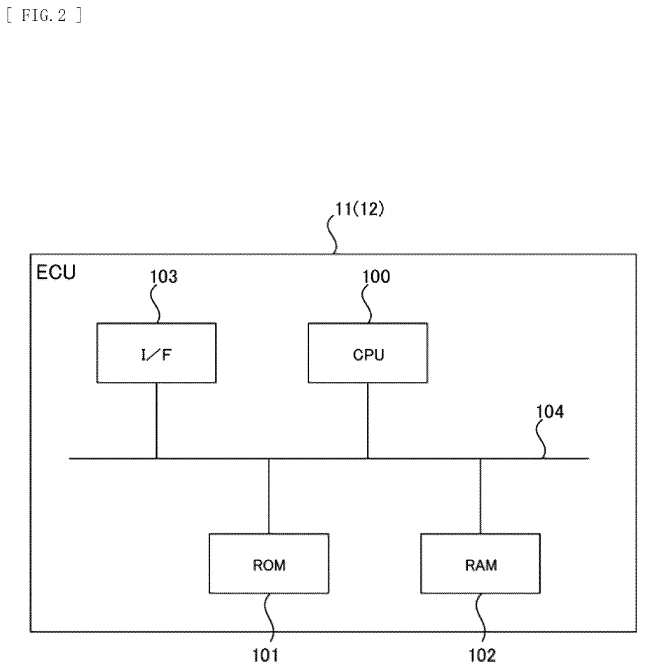

As illustrated in FIG. 2, the ECUs 11 and 12 each include a CPU (Central Processing Unit) 100, a ROM (Read Only Memory) 101, a RAM (Random Access Memory) 102, an I/F (Interface) 103, and the like, and the pieces of hardware are coupled to each other via a bus 104. The CPU 100 controls operation of the ECUs 11 and 12 by executing various programs stored in the ROM 101. The ROM 101 is a non-volatile memory. For example, the ROM 101 stores the program to be executed by the CPU 100 and information necessary for the CPU 100 to execute the program. The RAM 102 is a main storage device such as a DRAM (Dynamic Random Access Memory) or a SRAM (Static Random Access Memory). For example, the RAM 102 serves as a work area that the CPU 100 uses to execute the program. The I/F 103 controls transmission and reception of information to and from an external device (for example, the in-vehicle camera 2 or the headlamp device 3).

Control of the system 1 (an aiming method) performed by the controller 10 includes at least an initial setting operation mode, an operation mode at the time of replacement, and an ADB control operation mode.

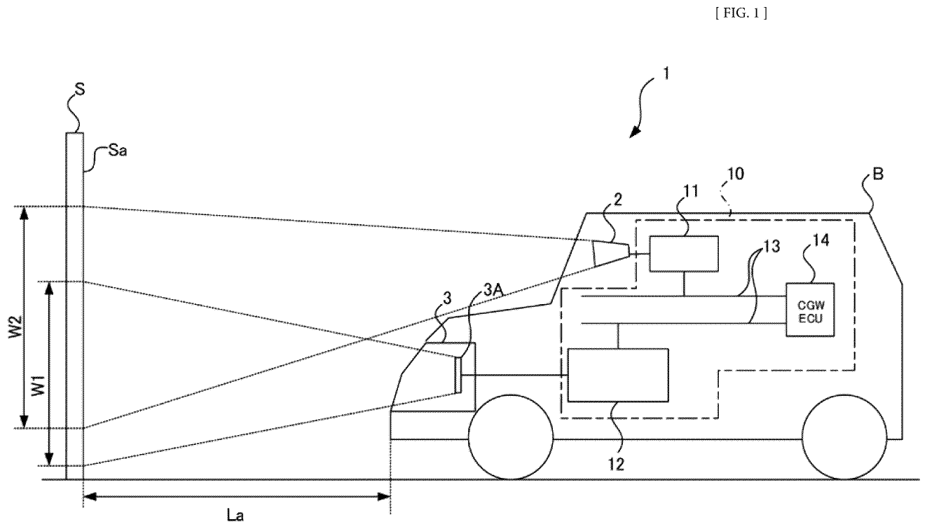

In the initial setting operation mode, as illustrated in FIG. 1, initial setting is performed by installing the vehicle B in accordance with initial setting conditions with respect to the screen S, illuminating the calibration illumination target surface Sa of the screen S with light from a specific segment of the light source unit 3A, and capturing an image of an illumination position by the in-vehicle camera 2. Set as the initial setting conditions here are, for example, a distance La from the screen S to a front end of the vehicle B, an illumination width W1 of the headlamp device 3 on the calibration illumination target surface Sa, and an imaging range W2 of the in-vehicle camera 2 on the calibration illumination target surface Sa.

At the time of initial setting when the initial setting operation mode is performed, optical axes of the headlamp device 3 and the in-vehicle camera 2 appropriately mounted on the vehicle B have been adjusted in advance. Therefore, a glare suppression function of the ADB control functions normally as long as this state at the time of initial setting is maintained.

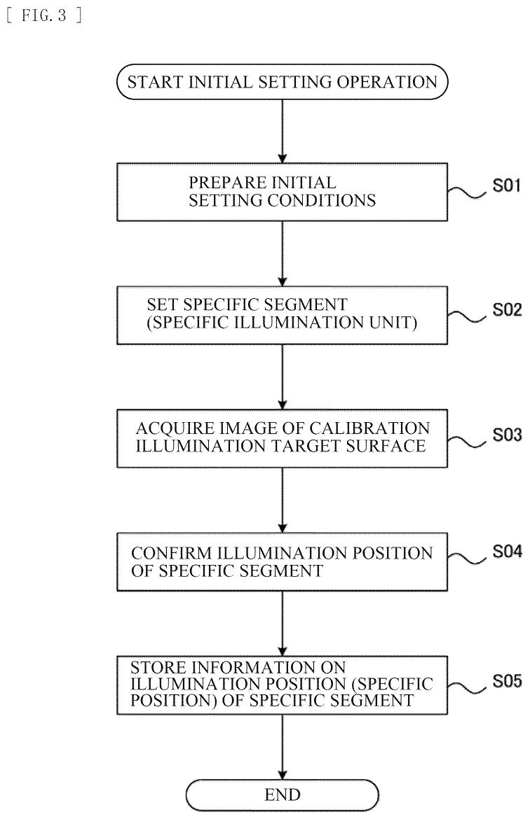

Now described is an operation example of the initial setting operation mode. As illustrated in FIG. 3, when the initial setting operation is started, the above-described initial setting conditions are prepared (step S01), a specific segment (specific illumination unit) of the light source unit 3A is set with respect to the calibration illumination target surface Sa of the screen S (step S02), light is emitted for illumination from the specific segment, and an image of the calibration illumination target surface Sa of the screen S is acquired by the in-vehicle camera 2 (step S03). Further, an illumination position (coordinates) of the specific segment in the acquired image is confirmed by image processing on the acquired image (step S04), and information on the confirmed illumination position is stored as a specific position (step S05).

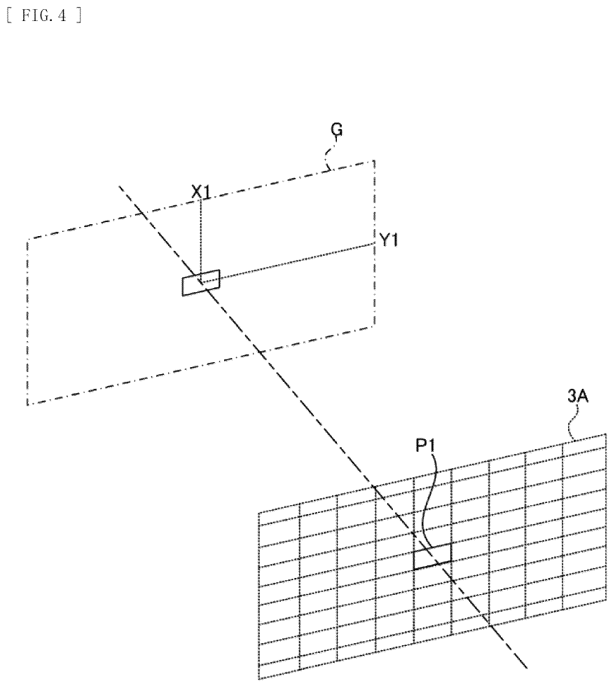

At the time of initial installation, the optical axis of the in-vehicle camera 2 and the optical axis of the headlamp device 3 have been adjusted in advance. Under the initial setting conditions for the screen S, information on the illumination position of a specific segment P1 on the calibration illumination target surface Sa is stored as a specific position (X1, Y1) in an acquired image G, as illustrated in FIG. 4. In this way, the state where the illumination position of the specific segment P1 on the calibration illumination target surface Sa matches the specific position (X1,Y1) in the acquired image G is the state at the time of initial setting. In this state, the glare suppression function of the ADB control functions appropriately.

The operation mode at the time of replacement is an operation mode performed when replacing the headlamp device 3. A deviation between the specific position (X1, Y1) stored as information in the initial operation mode and the illumination position of the specific segment in the light source unit 3A is detected, and a correction amount in the ADB control is calculated.

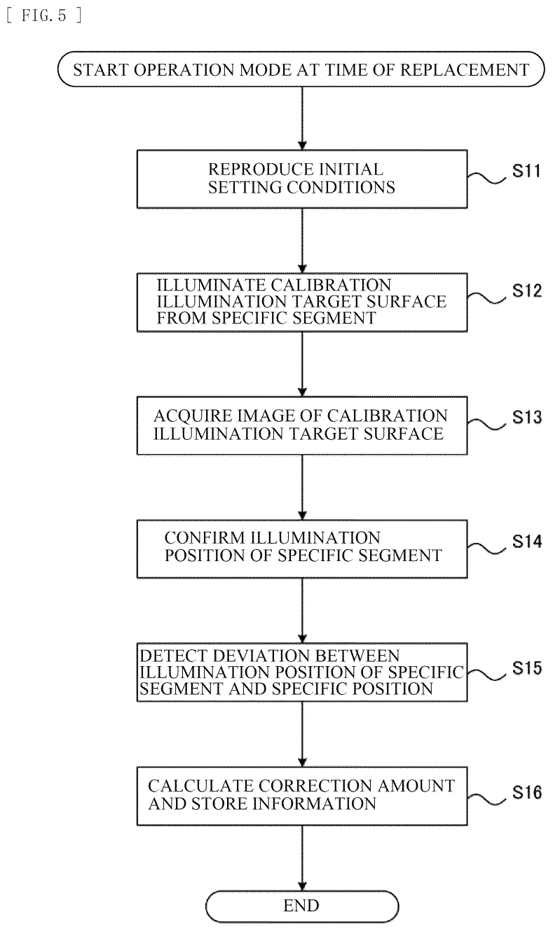

Now described is an operation example of the operation mode at the time of replacement. As illustrated in FIG. 5, when the operation at the time of replacement is started, the above-described initial setting conditions are reproduced (step S11), light is emitted for illumination from the specific segment (specific illumination unit) of the light source unit 3A to the calibration illumination target surface Sa of the screen S (step S12), and an image of the calibration illumination target surface Sa of the screen S is acquired by the in-vehicle camera 2 (step S13). Further, the illumination position (coordinates) of the specific segment in the acquired image is confirmed by image processing on the acquired image (step S14). The deviation between the confirmed illumination position and the specific position stored as information in the initial setting operation mode is detected (step S15), the correction amount in the ADB control is calculated based on the detected deviation, and information on the correction amount is stored (step S16).

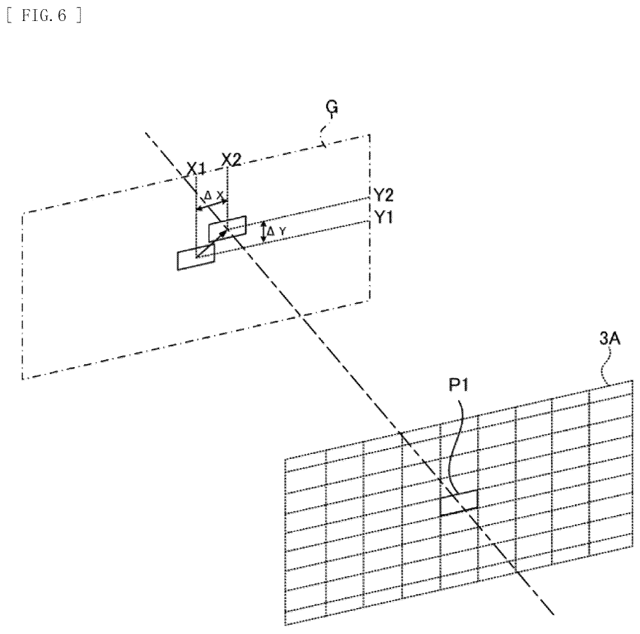

When replacing the headlamp device, the optical axis of the headlamp device 2 can deviate from that at the time of initial installation. In this case, even if the initial setting conditions are reproduced, an illumination position (X2,Y2) of the specific segment P1 on the calibration illumination target surface Sa deviates from the specific position (X1,Y1) in the acquired image G stored as information at the time of initial setting, and the correction amount of the ADB control is calculated based on this deviation (AX, AY), as illustrated in FIG. 6.

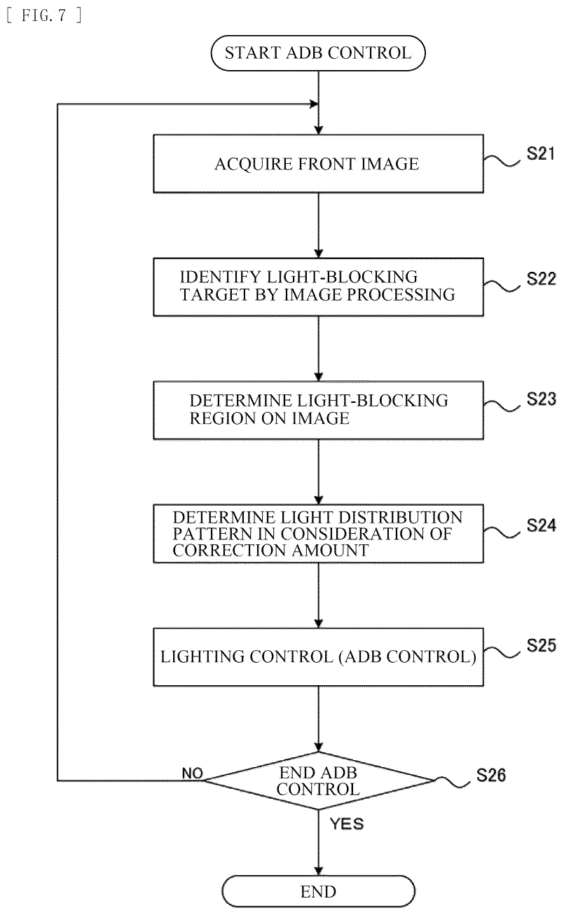

The ADB control operation mode is variable light distribution control of the headlamp device 3, performed when the vehicle is traveling. As illustrated in FIG. 7, when the ADB control is started, the front image is acquired by the in-vehicle camera 2 (step S21), a light-blocking target in the acquired image is identified by image processing on the acquired front image (step S22), and a light-blocking region on the acquired image is determined (step S23).

When the light-blocking region on the image is determined, a light distribution pattern is determined by determining a light-blocking segment of the light source unit 3A corresponding to the light-blocking region, in consideration of the correction amount stored as information in the operation mode at the time of replacement (step S24), and the lighting control of the light source unit 3A is performed based on the determined light distribution pattern. Thus, it is possible to execute appropriate ADB control with suppressed glare for the light-blocking target (step S25). Further, the above-described steps S21 to S25 are repeated in a case of continuing such ADB control (step S26: NO), and the control operation is ended in a case of ending the ADB control (step S26: YES).

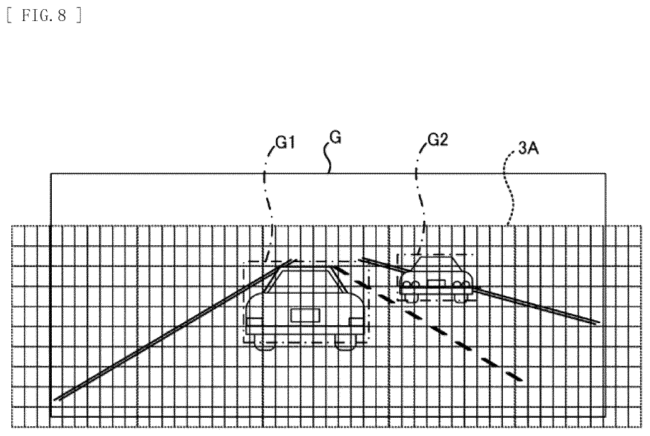

When the ADB control is executed, the light distribution pattern of the light source unit 3A is determined to perform light-blocking (or light reduction) for light-blocking regions G1 and G2 determined from the acquired image G of the in-vehicle camera 2, as illustrated in FIG. 8. Even if a deviation occurs between the optical axis of the headlamp device 3 and the vehicle body or the optical axis of the in-vehicle camera 2 due to, for example, replacement of the headlamp device 3, executing the ADB control considering the above-described correction amount makes it possible to perform appropriate ADB control to suppress glare for the light-blocking target, without adjusting the optical axis of the headlamp device 3.

Although some embodiments of the invention have been described with reference to the drawings, specific configurations are not limited to these embodiments, and the invention includes modifications of design or the like made within a range not departing from the gist of the invention. Further, the above-described embodiments may be combined by diverting the technologies to each other as long as there is no particular contradiction or issue in the purpose, configurations, or the like.

### Description of Reference Numerals

1: aiming system (system), 2: in-vehicle camera, 3: headlamp device, 3A: light source unit, 10: controller, 11, 12: ECU, 13: in-vehicle network, 14: central gateway (CGW ECU), 100: CPU, 101: ROM, 102: RAM, 103: I/F, S: screen, Sa: calibration illumination target surface, G: acquired image, G1, G2: light-blocking region, P1: specific segment

1. A vehicle headlamp device aiming system comprising:
an in-vehicle camera configured to capture a front image of an own vehicle;
a headlamp device configured to set a light illumination range in front of the own vehicle; and
a controller configured to perform variable light distribution control of identifying a light-reduction or light-blocking region in the light illumination range, based on a captured image by the in-vehicle camera, wherein
the controller is configured to
set, in the headlamp device, a specific illumination unit whose illumination position is a specific position in a captured image of a calibration illumination target surface captured by the in-vehicle camera, at a time of initial setting, and
detect a deviation between the specific position and the illumination position of the specific illumination unit, in the captured image of the calibration illumination target surface captured by the in-vehicle camera, and corrects an output of the variable light distribution control in accordance with the deviation.

2. The vehicle headlamp device aiming system according to claim 1, wherein the headlamp device comprises illumination units arranged in a dot matrix, and the specific illumination unit is identified as one or more of the illumination units.

3. A vehicle headlamp device aiming method that performs variable light distribution control of identifying a light-reduction or light-blocking region, based on a captured image by an in-vehicle camera, the vehicle headlamp device aiming method comprising:
setting, in a headlamp device, a specific illumination unit whose illumination position is a specific position in a captured image of a calibration illumination target surface captured by the in-vehicle camera, at a time of initial setting; and
detecting a deviation between the specific position and the illumination position of the specific illumination unit, in the captured image of the calibration illumination target surface captured by the in-vehicle camera, and correcting an output of the variable light distribution control in accordance with the deviation, at a time of calibration.
